(19) United States
(12) Patent Application Publication
(10) Pub. No.: US 2008/0302332 A1
(43) Pub. Date: Dec. 11, 2008

(54) SPLIT-BORE STRATIFIED CHARGE CARBURETOR

(75) Inventors: Paul J. Dow, Cass City, MI (US); Jeffrey D. Hanby, Cass City, MI (US)

Correspondence Address: REISING, ETHINGTON, BARNES, KISSELLE, P.C., P O BOX 4390, TROY, MI, 48099-4390, US

(73) Assignee: WALBRO ENGINE MANAGEMENT, L.L.C., Tucson, AZ (US)

(21) Appl. No.: 11/758,309

(22) Filed: Jun. 5, 2007

(51) Int. Cl. F02M 7/12

(52) U.S. Cl. 123/434

(57) ABSTRACT

A carburetor includes a body, a fuel metering system carried by the body to regulate fuel flow to the body, and a fuel-and-air mixing passage in fluid communication with the fuel metering system. The mixing passage extends through the body and is partitioned into a rich mixture passage, and a lean mixture passage positioned between the rich mixture passage and the fuel metering system.

### FIELD OF THE INVENTION

The present invention relates generally to fuel systems for internal combustion engines, and more particularly to a stratified charge carburetor for a stratified scavenging two-stroke engine.

### BACKGROUND OF THE INVENTION

In general, a carburetor is a useful device for forming a combustible charge or mixture of fuel and air for delivery to an internal combustion engine. The carburetor meters liquid fuel for mixing with air to adjust a fuel-to-air ratio, according to varying engine requirements during engine startup, idle, steady-state operation, and changes in load and altitude.

A diaphragm-type of carburetor is typically used with small two-stroke internal combustion engines commonly used in hand-held power tools such as chain saws, weed trimmers, leaf blowers, and the like. In the diaphragm carburetor, a body defines a mixing passage with an air inlet and a downstream fuel-and-air mixture outlet. A throttle valve is disposed in the fuel-and-air mixing passage downstream of the air inlet for controlling delivery of a primary fuel-and-air mixture to the engine. A typical diaphragm fuel metering system includes a metering valve, and a flexible diaphragm carried by the body and partially defining and separating a fuel chamber from the atmosphere. The metering valve and diaphragm control fuel flow from the diaphragm fuel pump to the fuel chamber for delivery from the fuel chamber to the fuel-and-air mixing passage.

A scavenging-type of diaphragm carburetor is used with a stratified scavenging type of engine to reduce scavenging losses or blow-through of some of the fuel-and-air mixture out of engine exhaust ports. A scavenging carburetor is known to have a fuel-and-air mixture passage and a separate scavenging air passage that both communicate at one end of the carburetor with a clean air source at atmospheric pressure, such as air filter. At an opposite end of the carburetor, the fuel-and-air mixture passage and the separate scavenging air passage communicate with an engine crankcase and an engine combustion chamber, respectively.

### SUMMARY OF THE INVENTION

A carburetor includes a body, and a fuel metering system carried by the body to regulate fuel flow to the body. The carburetor also includes a fuel-and-air mixing passage in fluid communication with the fuel metering system. The mixing passage extends through the body and is partitioned into a rich mixture passage, and a lean mixture passage positioned between the rich mixture passage and the fuel metering system.

According to another potential aspect of the carburetor, at least one partition may be carried by the body in the fuel-and-air mixing passage to at least partially partition the mixing passage into the rich and lean mixture passages. Also, the at least one partition may include a venturi profile. A throttle valve and/or choke valve may be disposed in the fuel-and-air mixing passage to further at least partially define(s) the rich and lean mixture passages at least when in a substantially open position.

According to additional potential aspects of the carburetor, a low and/or a high speed fuel path may be in communication from the fuel metering system, from one side of a center line of the mixing passage to another, to the rich mixture passage. Also, a low speed fuel shutoff apparatus may be in fluid communication with the low speed fuel path, and a high speed accelerator pump apparatus may be in fluid communication with the high speed fuel path. The low speed fuel shutoff apparatus may include a bore in the body, a valve carried by the body in the bore and defining a valve chamber in fluid communication with the low speed fuel path, and a relieved portion of a throttle shaft carried by the body, wherein the valve is movable upon rotation of the throttle shaft to block flow of fluid through the low speed fuel path. The high speed acceleration pump apparatus may include a bore in the body, a piston carried by the body in the bore and defining a pressure chamber in fluid communication with the high speed fuel path, and a relieved portion of a throttle shaft carried by the body, wherein the piston is movable upon rotation of the throttle shaft to pressurize and displace fluid out of the pressure chamber and into the high speed fuel path toward the rich mixture passage.

At least some of the objects, features and advantages that may be achieved by at least certain embodiments of the invention include a carburetor design that enables a reduction in size and weight of a stratified charge carburetor; maintains location of carburetor controls of an existing carburetor; maintains location of engine intake ports of an existing engine; and is of relatively simple design, economical manufacture and assembly, rugged, durable, reliable, and in service has a long useful life.

Of course, other objects, features and advantages will be apparent in view of this disclosure to those skilled in the art. Various other carburetors embodying the invention may achieve more or less than the noted objects, features or advantages.

### BRIEF DESCRIPTION OF THE DRAWINGS

These and other objects, features and advantages of the present invention will be apparent from the following detailed description of preferred embodiments and best mode, appended claims, and accompanying drawings in which:

FIG. 1 is a front perspective view of a presently preferred form of a stratified charge carburetor showing an engine mounting face;

FIG. 2 is a rear perspective view of a presently preferred form of a stratified charge carburetor showing an air filter mounting face;

FIG. 3 is a cross-sectional view of the carburetor of FIG. 1, taken along line 3-3 of FIG. 2, and also showing a portion of a stratified scavenging two-stroke engine and an adapter between the engine and carburetor;

FIG. 4 is a staggered cross-sectional view of the carburetor of FIG. 1 illustrating fuel discharge ports;

FIG. 5 is a cross-sectional view of the carburetor of FIG. 1, showing a portion of a low speed fuel path;

FIG. 6 is a cross-sectional view of the carburetor of FIG. 1, showing a portion of a high speed fuel path;

FIG. 7 is a cross-sectional view of the carburetor of FIG. 1, illustrating a fuel shutoff valve in an open position;

FIG. 8 is a cross-sectional view of the carburetor like FIG. 7, illustrating the fuel shutoff valve of FIG. 7 in a closed position;

FIG. 9 is a cross-sectional view of the carburetor of FIG. 1, illustrating an accelerator piston in a retracted position; and

FIG. 10 is cross-sectional view of the carburetor like FIG. 9, illustrating the accelerator piston of FIG. 9 in an advanced position.

### DETAILED DESCRIPTION OF PREFERRED EMBODIMENTS

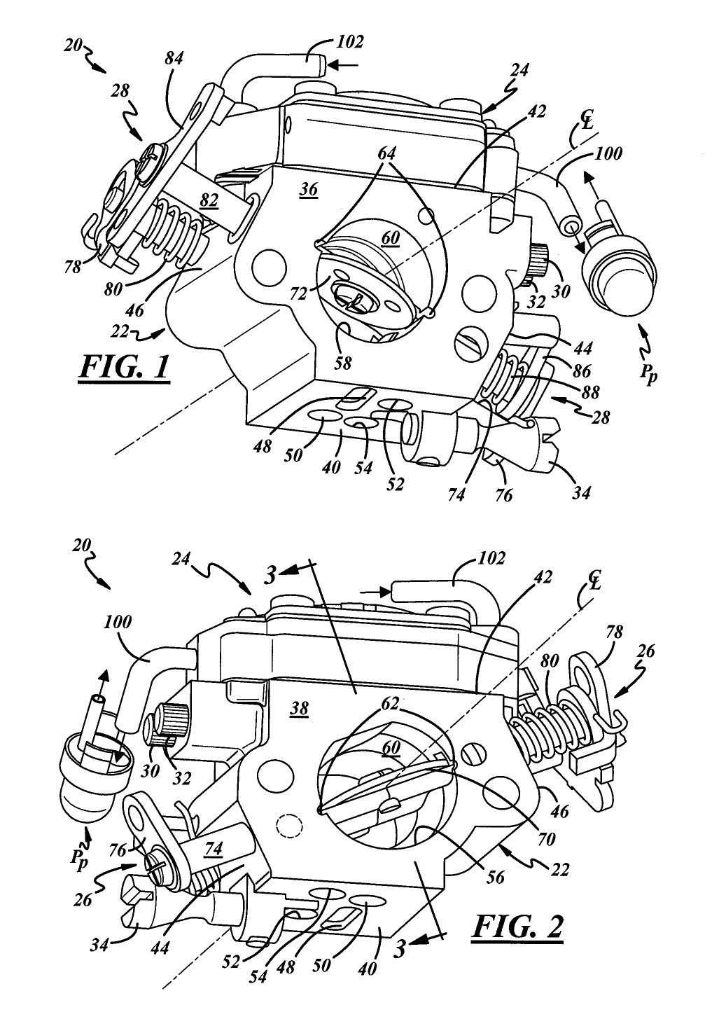

Referring in more detail to the drawings, FIGS. 1 and 2 illustrate a split-bore stratified-charge carburetor 20 for producing a fuel-and-air mixture to a stratified-scavenging two-stroke engine (not shown). Those skilled in the art will recognize that scavenging generally may include the removal of spent gases from an internal combustion engine cylinder and replacement by a fresh charge of a fuel-and-air mixture or of pure air.

The carburetor 20 generally includes a body 22 for mixing fuel and air, and a fuel metering system 24 carried by the body 22 for pressurizing and regulating fuel to be supplied to the body 22. The carburetor 20 may also include a choke shaft and valve assembly 26 carried by the body 22 for restricting air flow into the carburetor 20, and a throttle shaft and valve assembly 28 carried by the body 22 for adjusting flow of the fuel-and-air mixture out of the carburetor 20. Further, the carburetor 20 may include low and high speed adjustment valves 30, 32 to adjust the pressurized and apportioned fuel from the fuel metering system 24, and an idle adjustment screw 34 carried by the body 22 and adapted to cooperate with the throttle assembly 28 to adjust fuel and air supply to the engine during engine idling.

The body 22 generally provides structural support for mixing of fuel and air as will be described in further detail herein below. The body 22 may be composed of aluminum or any other suitable material, and may be cast and subsequently machined or constructed in any other suitable manner.

Externally, the body 22 may include a first face 36 such as an engine mounting face, and an oppositely disposed second face 38 such as an air filter mounting face. The body 22 may also include a bottom 40 and an oppositely disposed top 42, which is adapted to carry the fuel metering system 24. The body 22 may additionally include opposed sides 44, 46, between which portions of the choke and throttle assemblies 26, 28 extend.

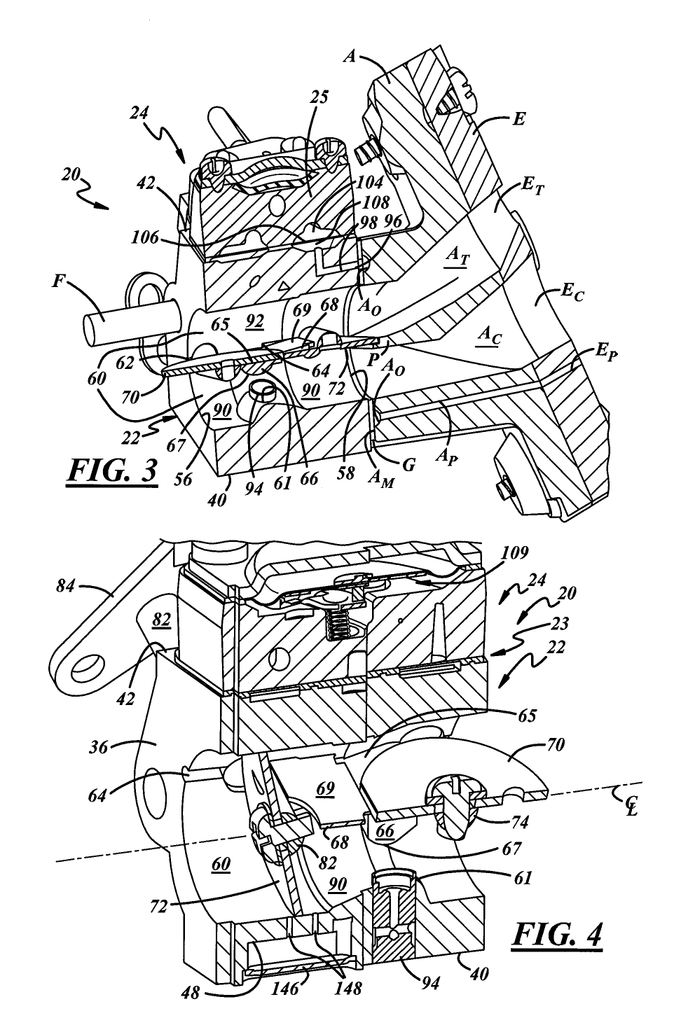

Internally, the body 22 includes several passages and voids. The bottom 40 may include several voids including a low speed progression pocket 48, a high speed jet nozzle passage 50, and low and high speed fuel transfer pockets 52, 54. Also, the body 22 may include an air inlet aperture 56 in the filter mounting face 38, a fuel-and-air mixture outlet aperture 58 in the engine mounting face 36, and a fuel-and-air mixing passage 60 extending between the faces 36, 38 in communication with the apertures 56, 58. The inlet aperture 56 may be in communication with an atmospheric air source such as an air filter (not shown). The body 22 also may include one or more sets of opposed slots 62, 64 extending between the faces 56, 58 and in open communication with the mixing passage 60 for accepting one or more partitions 66, 68, which are best shown in FIGS. 3 and 4.

The choke shaft and valve assembly 26 includes a choke valve head 70, a choke shaft 74 extending through the body 22 transversely across the mixing passage 60 to carry the choke valve head 70, and suitable levers 76, 78 and a return spring 80. The throttle shaft and valve assembly 28 includes a throttle valve head 72, a shaft 82 extending through the body 22 transversely across the mixing passage 60 to carry the throttle valve head 72, and suitable levers 84, 86 and a return spring 88. The return springs 80, 88 preferably bias the valves 70, 72 to their default positions as best shown in FIG. 4.

Referring to FIG. 3, the outlet aperture 58 may be in communication with an engine E and/or an adapter A between the engine E and carburetor 20 with a gasket G therebetween. The adapter A may be a separate component or may be an integral part of the engine E. The engine E may be a stratified scavenging two-stroke internal combustion engine. Accordingly, the carburetor 20 is configured for mounting to the adapter A and may be retained thereto in any suitable manner, such as by any suitable fasteners F. The engine E includes a transfer port E_{T} and a crankcase port E_{C} in respective communication with a transfer passage A_{T} and a crankcase passage A_{C} of the adapter A. In turn, the transfer and crankcase passages A_{T}, A_{C} generally communicate with the mixing passage 60 of the carburetor 20. More specifically, the passages A_{T}, A_{C} respectively communicate with lean and rich mixture passages 92, 90.

The fuel-and-air mixing passage 60 is partitioned into a rich mixture passage 90 and a lean mixture passage 92 positioned between the rich mixture passage 90 and the fuel metering system 24. The rich and lean mixture passages 90, 92 are generally defined by one or more of the open choke valve 70, open throttle valve 72, and/or the partition(s) 66, 68 within the partitioned fuel-and-air mixing passage 60.

As shown in FIGS. 3 and 4, the partitions 66, 68 may include a choke partition 66, and a throttle partition 68. The choke partition 66 may include a generally planar surface 65 against which a portion of the choke valve head 70 rests when in an open position. The choke partition 66 also may include a venturi profile 67 generally opposite of the planar surface 65 and in communication with the rich mixture passage 90. As used herein, the term venturi includes a passage of any shape and size constructed and arranged to cause a drop in pressure as fluid flows through it. The fuel-and-air mixing passage 60 may include a venturi portion 61 downstream of the inlet 56 and upstream of the outlet 58. The venturi portion 61 may be a necked down portion of the mixing passage 60 and may be generally opposed to the venturi profile 67 of the choke partition 66. The venturi profile 67 of the choke partition 66 and the body venturi portion 61 may collectively define a venturi passage through which incoming air may flow and into which incoming fuel may flow through a high speed jet nozzle 94.

As shown in FIG. 3, the engine mounting face 36 (FIG. 1) of the carburetor body 22 may also include an opening 96 of a passage 98, which may be in communication with the fuel metering system 24 as will be described further herein below. The opening 96 may be adapted to communicate in any suitable manner with a crankcase (not shown) of the engine E to supply engine crankcase pulses to power an integrated fuel pump 23 (FIG. 4) of the fuel metering system 24. For example, the crankcase may be in communication with an engine pulse passage E_{P} extending through a portion of the engine E, wherein the passage E_{P} is in communication with an adapter pulse passage A_{P} extending through a portion thereof The adapter pulse passage A_{P} communicates with the carburetor opening 96 via an open circumferential channel A_{O} in a mounting face A_{M} of the adapter A.

Referring again to FIGS. 1 and 2, the fuel-and-air mixing passage 60 is supplied with fuel from the fuel metering system 24. The fuel metering system 24 receives fuel from a separate fuel pump or fuel tank (not shown) and delivers fuel at a controlled rate to the fuel-and-air mixing passage 60 through the body 22. The fuel metering system 24 may also include the integrated fuel pump 23 (FIG. 4). An exemplary fuel metering system is disclosed in U.S. Pat. No. 6,715,737, which is assigned to the assignee hereof and is incorporated herein by reference in its entirety. A purge pump P_{P} is schematically shown in fluid communication with a purge fitting 100 of the fuel metering system 24 for manual purging of fuel vapor and air from the fuel metering system 24 to the fuel tank. Fuel enters the fuel metering system 24 from the fuel tank through an inlet fitting 102 of the fuel metering system 24.

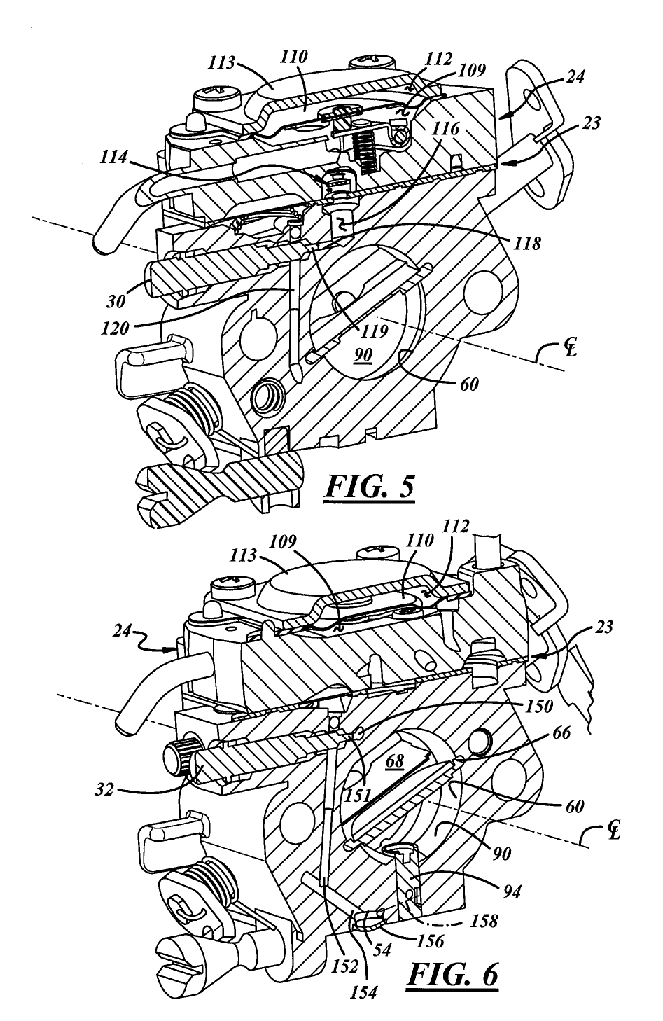

Referring to FIG. 3, incoming fuel may flow through suitable passages (not shown) to a fuel pump chamber 104 on one side of a pump diaphragm 106, and crankcase pressure pulses flow to a pulse chamber 108 on the other side of the diaphragm 106 to pulsate the diaphragm 106 and thereby pump the fuel. The diaphragm 106 may be disposed between the top 42 of the carburetor 20 and a bottom of a body 25 of the fuel metering system 24. The pressurized fuel flows from the pump chamber 104 through any number of suitable passage(s) and valve(s) (not shown) to a fuel metering chamber 109 on one side of a metering diaphragm 110 opposite an atmospheric reference chamber 112 partially defined by a cover 113, as shown in FIG. 5. The metered fuel flows from the metering chamber 109 through a check valve 114 and into a collection chamber 116 upstream of the adjustment valves 30, 32.

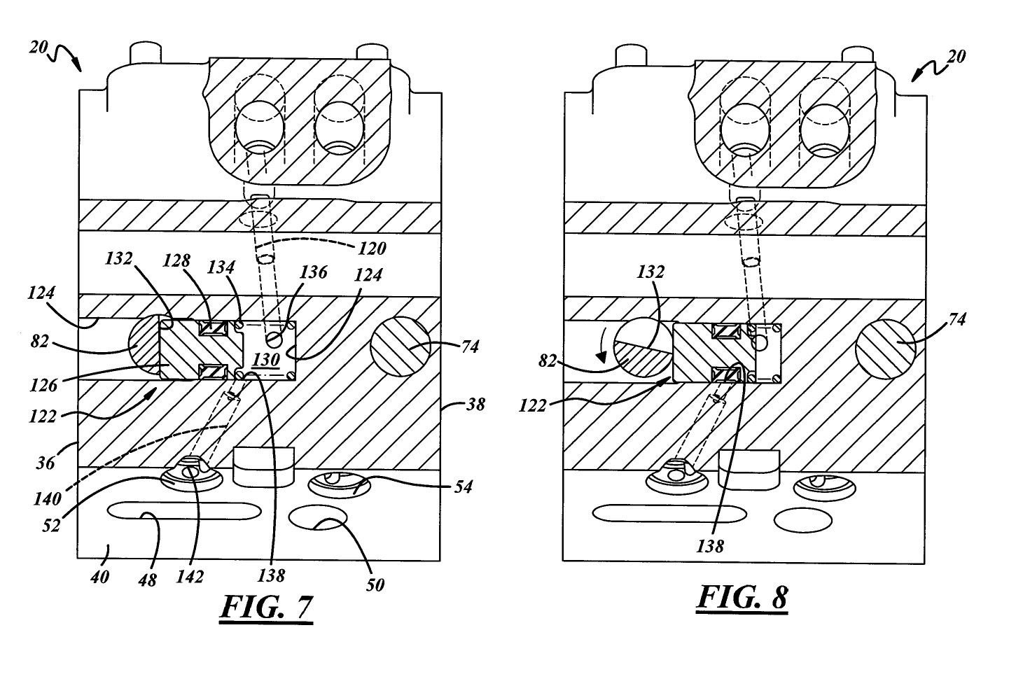

FIG. 5 illustrates a portion of a low speed fuel path extending in fluid communication from the fuel metering system 24, from one side of a center line C_{L} of the mixing passage 60 to another, and through the body 22 to the rich mixture passage 90. The fuel flows from the collection chamber 116 to a passage 118, around a needle end 119 of the low speed adjustment valve 30, to a passage 120 that extends to a chamber 130 (FIG. 7). As shown in FIG. 7, the chamber 130 communicates with a passage 140 that leads to a transfer pocket 52 closed by a plug (not shown). The transfer pocket 52 is open to a passage 142 that leads to a progression pocket 48 (FIG. 4) closed by a plug 146. The progression pocket 48 is communicated with the rich mixture passage 90 through one or more low speed jets 148 (FIG. 4). Accordingly, during at least low speed operating conditions, fuel from the metering chamber is communicated with the rich mixture passage 90 through this low speed fuel path.

As best shown in FIGS. 7 and 8, to selectively restrict or prevent fuel flow through the low speed fuel path, a shutoff valve 122 may be provided. The shutoff valve 122 may include a body 126 slidably disposed in a bore 124 that defines part of the fuel chamber 130. The body 126 may carry a seal 128 that seals the fuel chamber 130, and a return spring 134 may bias the body 126 into engagement with the throttle valve shaft 82. The throttle valve shaft 82 may include a cam 132 that, at least when the throttle valve is in its idle position, bears on the body 126.

Accordingly, when the throttle valve is rotated away from its idle position, the cam 132 displaces the body 126 from a first position, shown in FIG. 7, wherein the passage 120 is communicated with the passage 140 to a second position, shown in FIG. 8, wherein the body prevents communication between the passages 120, 140 (e.g. by blocking the passage 140) to close the low speed fuel path. When the throttle valve is rotated back toward its idle position, the return spring 134 displaces the body back toward its first position to reopen the low speed fuel path. In this manner, the low speed fuel flow path can be closed when the throttle valve is moved sufficiently away from its idle position to permit fuel flow through this path only during low speed and low load engine operation.

FIG. 6 illustrates a portion of a high speed fuel path extending in fluid communication from the fuel metering system 24, from one side of the center line C_{L} of the mixing passage 60 to another, to the rich mixture passage 90. The fuel flows from the collection chamber 116 (FIG. 5) through a horizontal passage 150 (FIG. 6), around a needle portion 151 of the high speed adjustment valve 32, and into and through a relatively vertical passage 152. The fuel then flows into and through an angled passage 154 to a transfer chamber defined by the transfer pocket 54 and a Welch plug 156. Then the fuel flows through a passage 158 into communication with the jet nozzle passage 50 (FIGS. 1 and 2) and, ultimately, through the jet nozzle 94 to the rich mixture passage 90 of the mixing passage 60.

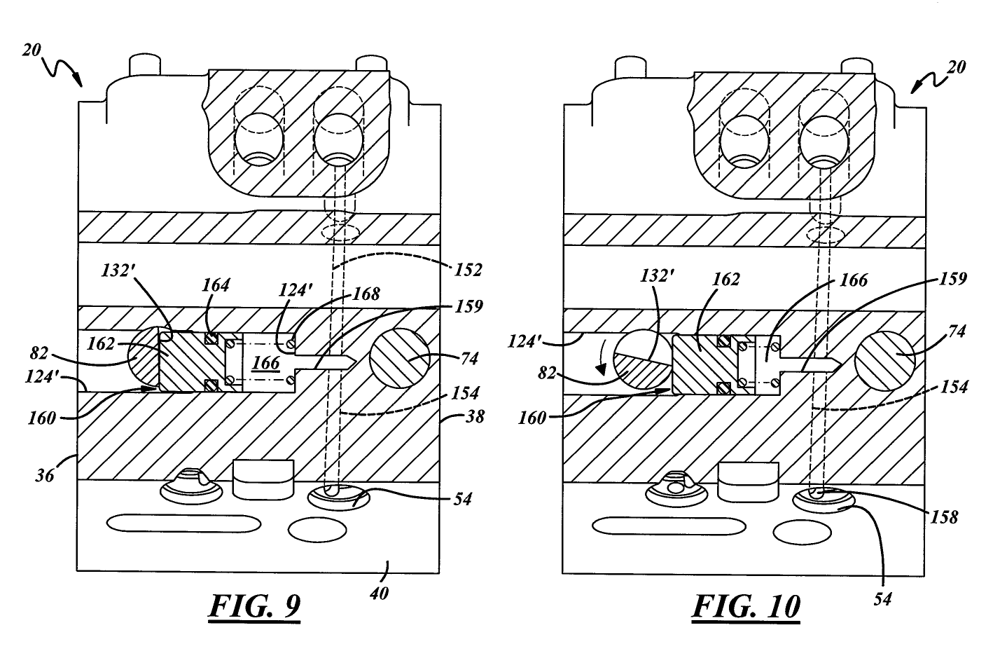

As shown in FIG. 9, fuel may flow from the high speed flow path and may communicate with an accelerator pump 160, such as through a passage 159 leading to a pump chamber 166. The accelerator pump 160 may include a body 162 disposed in a bore and carrying a seal 164 to seal the pump chamber 166. The accelerator pump 160 may also include a pressure chamber 166, which may be defined by one end of the body 162 and an end of a bore 124′, a cam 132′ of the throttle valve shaft 82, and a piston return spring 168. Under low speed or idle operation, fuel flows into the pressure chamber 166 and deadheads there.

But, referring to FIG. 10, when the throttle valve is moved toward its wide open throttle (WOT) position, the throttle valve shaft rotates and the cam displaces the body 162. This causes the body to pressurize the fuel in the pressure chamber 166 and discharge it through the passage 159, the angled passage 154, the transfer chamber, the passage 158, and, ultimately, through the high speed jet nozzle 94 to the rich mixture passage 90 of the mixing passage 60. Accordingly, when the carburetor 20 is commanded from an idle operation state to a WOT operation state, a charge of fuel from the pressure chamber 166 may be quickly injected through the carburetor 20 into the engine to increase responsiveness of engine acceleration.

Any suitable accelerator pump apparatus and/or any suitable shutoff valve apparatus may be used such as another exemplary apparatus disclosed in U.S. Pat. No. 5,250,233, which is assigned to the assignee hereof and is incorporated herein by reference in its entirety. Accordingly, the carburetor 20 may also or instead include any suitable combined accelerator pump and shut off valve apparatus(es).

Referring to FIGS. 3 and 4, the carburetor 20 may operate in partially stratified and fully stratified modes. In a first partially stratified mode, the throttle valve 72 may be in its idle position as shown in FIG. 4 so that a downstream one of the low speed jets 148 is open, in downstream exposure to the engine E. For example, the first partially stratified mode may be used for engine idling. In a second partially stratified mode, the throttle valve 72 may be rotated slightly from its idle position so that both of the low speed jets 148 are open. For example, the second partially stratified mode may be used for engine cold starting. In either or both of these modes, fuel may become entrained in air, which is drawn by the engine E, and thereby may flow through both the rich and lean mixture passages 90, 92 of the fuel-and-air mixing passage 60 and into the crankcase and transfer passages A_{C}, A_{T}, respectively. In either or both of these modes, the choke valve 70 may be fully open as shown, or may be completely closed, or may be rotated anywhere in between.

In the fully stratified mode, the throttle valve 72 may be fully open as shown in FIG. 3 such that a downstream side engages a partition P of the adapter A or engine E. The throttle valve 72 is opened so that both of the low speed jets 148 and the high speed jet nozzle 94 are open, in downstream exposure to the engine E. Fuel may become entrained in air, which is drawn by the engine E, and may thereby flow primarily or only through the rich mixture passage 90 of the fuel-and-air mixing passage 60 and into the crankcase passage A_{C}. In this case, primarily or only air may flow through the lean mixture passage 92, such that the lean mixture passage 92 effectively operates as a scavenging passage of the carburetor 20. In this mode, the choke valve 70 may be fully open as shown, or may be completely closed, or may be rotated anywhere in between. For example, the fully stratified mode may be used in wide-open-throttling of the engine E.

Compared to conventional stratified charge carburetors, the exemplary carburetor 20 may provide one or more benefits. For example, the carburetor 20 may be relatively smaller and lighter than other stratified charge carburetors, such as on the order of about 32% shorter in height from top to bottom, about 14% shorter in length between the mounting faces, and about 18% lighter. In another example, routing of the low and high speed fuel paths through the carburetor body beyond the centerline of the fuel-and-air mixing passage may facilitate incorporation of an accelerator pump and/or shut off valve apparatus(es). In a further example, packaging of the fuel metering system on top of the carburetor enables use of an existing location of carburetor controls and use of an existing location of engine intake ports.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

What is claimed is:

1. A carburetor, comprising:
a body;
a fuel metering system carried by the body to regulate fuel flow to the body; and
a fuel-and-air mixing passage in fluid communication with the fuel metering system, the mixing passage extending through the body and being partitioned into a rich mixture passage, and a lean mixture passage positioned between the rich mixture passage and the fuel metering system.

2. The carburetor of claim 1, further comprising at least one partition carried by the body in the fuel-and-air mixing passage and at least partially partitioning the fuel-and-air mixing passage into the rich and lean mixture passages.

3. The carburetor of claim 2, wherein the at least one partition includes a venturi profile.

4. The carburetor of claim 2, further comprising a throttle valve disposed in the fuel-and-air mixing passage and also at least partially defining the rich and lean mixture passages at least when in a substantially open position.

5. The carburetor of claim 3, further comprising a choke valve disposed in the fuel-and-air mixing passage upstream of the throttle valve and also at least partially defining the rich and lean mixture passages at least when in a substantially open position.

6. The carburetor of claim 1, further comprising a low speed fuel path communicating the fuel metering system and the rich mixture passage.

7. The carburetor of claim 6, further comprising a low speed fuel shutoff apparatus in fluid communication with the low speed fuel path.

8. The carburetor of claim 7, wherein the low speed fuel shutoff apparatus includes a bore in the body, a valve carried by the body in the bore and defining a valve chamber in fluid communication with the low speed fuel path, and a cam actuated by a throttle shaft wherein the valve is movable upon rotation of the throttle shaft to block flow of fluid through the low speed fuel path.

9. The carburetor of claim 1, further comprising a high speed fuel path in communication from the fuel metering system, from one side of a center line of the mixing passage to another, to the rich mixture passage.

10. The carburetor of claim 9, further comprising a high speed accelerator pump apparatus in fluid communication with the high speed fuel path.

11. The carburetor of claim 10, wherein the high speed acceleration apparatus includes a bore in the body, a piston carried by the body in the bore and defining a pressure chamber in fluid communication with the high speed fuel path, and a cam actuated by a throttle shaft wherein the piston is movable upon rotation of the throttle shaft to pressurize and displace fluid out of the pressure chamber and into the high speed fuel path toward the rich mixture passage.

12. The carburetor of claim 1, wherein the fuel metering system includes an integrated fuel pump to pressurize fuel supplied to the body.

13. A carburetor, comprising:
a fuel metering system to regulate fuel flow; and
a body carrying the fuel metering system and including:
a fuel-and-air mixing passage extending through the body and being in fluid communication with the fuel metering system;
at least one partition disposed in the mixing passage to divide the mixing passage into a rich mixture passage, and a lean mixture passage positioned between the rich mixture passage and the fuel metering system;
a low speed fuel path communicating the fuel metering system and the rich mixture passage; and
a high speed fuel path communicating the fuel metering system and the rich mixture passage.

14. The carburetor of claim 13, wherein the body further includes a venturi portion in the mixing passage and the partition includes a venturi profile that combines with the venturi portion of the body to define a venturi passage within the fuel-and-air mixing passage.

15. The carburetor of claim 13, wherein the low speed fuel path further includes a low speed fuel shutoff apparatus.

16. The carburetor of claim 14, wherein the low speed fuel shutoff apparatus includes a bore in the body, a valve carried by the body in the bore and defining a valve chamber in fluid communication with the low speed fuel path, and a cam actuated by a throttle shaft carried by the body, wherein the valve is movable upon rotation of the throttle shaft to block flow of fluid through the low speed fuel path.

17. The carburetor of claim 13, wherein the high speed fuel path further includes an accelerator pump apparatus.

18. The carburetor of claim 17, wherein the accelerator pump apparatus includes a bore in the body, a piston carried by the body in the bore and defining a pressure chamber in fluid communication with the high speed fuel path, and a cam actuated by a throttle shaft carried by the body, wherein the piston is movable upon rotation of the throttle shaft to pressurize and displace fluid out of the pressure chamber and into the high speed fuel path toward the rich mixture passage.

19. The carburetor of claim 13, further comprising a throttle valve and a choke valve disposed in the fuel-and-air mixing passage and also at least partially defining the rich and lean mixture passages at least when in substantially open positions.

20. The carburetor of claim 13, wherein the fuel metering system includes an integrated fuel pump to pressurize fuel supplied to the body.

21. A partition configured to be carried by a body of a carburetor within a fuel-and-air mixing passage of the carburetor, the partition comprising a venturi profile.

22. A carburetor including the partition of claim 21.
